(19) United States
(12) Patent Application Publication
(10) Pub. No.: US 2016/0221462 A1
(43) Pub. Date: Aug. 4, 2016

(54) SYSTEM AND METHOD FOR CHARGING A TRACTION BATTERY LIMITING THE CURRENT DRAW OF PARASITIC CAPACITANCES

(71) Applicant: RENAULT S.A.S., Boulogne Billancourt (FR)

(72) Inventors: Christophe RIPOLL, Chevreuse (FR); Mehdi GATI, Sceaux (FR); Olivier REYSS, Montrouge (FR)

(73) Assignee: RENAULT s.a.s., Boulogne Billancourt (FR)

(21) Appl. No.: 14/917,466

(22) PCT Filed: Sep. 24, 2014
(86) PCT No.: PCT/FR2014/052379

§ 371 Date: Mar. 8, 2016

(30) Foreign Application Priority Data
Oct. 1, 2013 (FR) 1359483

(51) Int. Cl. B60L 11/18

(52) U.S. Cl. CPC B60L 11/1838; B60L 11/1818

(57) ABSTRACT

A system charges a traction battery of an at least partially electric traction vehicle. The system includes an input filter connected to a power supply network. The filter includes a capacitance connected through a switch of the filter between at least one power supply phase connection or a neutral connection of the charging system, and a ground of the charging system. The system includes a controller for charging parasitic capacitances of the charging system without transferring energy from the power supply network to the battery while the power supply network is connected to the charging system. The system includes a time delay for closing the switch of the filter when a delay time frame higher than or equal to a predetermined time frame expires. The system also includes a charging activator for transferring energy between the power supply network and the battery, the switch of the filter being closed.

This invention relates in a general manner to the domains of electro-technology and the automobile. More precisely, the invention relates to a system for charging a traction battery of an electric or hybrid vehicle.

Charging systems for these types of vehicle each comprise one or more current converters enabling the current supplied by the power supply network to which the corresponding vehicle is connected to be adapted to a current making it possible to charge a traction battery of the vehicle. Leakage currents, produced during this current conversion, transit through parasitic capacitances called common mode, each one connecting elements of the charging system to the vehicle chassis, then through the ground to which the vehicle is connected via a ground connector. Depending on their amplitudes and frequencies, they are likely to cause protection circuit breakers to trip and therefore to prohibit or stop charging of the vehicle battery.

In order to limit these leakage currents, a first possibility is to isolate the network charging system via a galvanic transformer. However, such a transformer is bulky and costly, especially as the charging power of the traction battery is high, which is detrimental to the development of low cost electric vehicles having satisfactory autonomy.

Patent FR2964506 proposes, in order to limit these leakage currents, a vehicle charging system comprising a capacitance for limiting leakage currents, connected between a neutral phase of a power supply network to which the vehicle is connected and the vehicle chassis, the latter being connected to ground. A portion of the leakage currents generated during functioning of the charging system will thus be diverted to the neutral of the power supply network.

This solution, applicable to built-in chargers for electric or hybrid vehicles, not isolated from the power supply network by a galvanic transformer, nevertheless has a disadvantage: during initial positioning of the power switches of such a charger, the capacitive components existing on the high voltage potentials of the charger, together with the filtering components such as the capacitance for limiting leakage currents, are likely to interact with the power supply network.

In fact, these capacitive components cause, during a transient phase, a current draw enabling them to charge themselves to a voltage close to that of the power supply network. During this transient phase, a loop of current circulates at the charger input, which can be modeled by a circuit comprising the ground, the power supply network, an equivalent charger input common mode inductance and an equivalent charger input common mode capacitance, this same being connected to ground. The current in this input loop resonates at a frequency of the order of a few kHz (kilohertz). The common mode current thus created circulates on the power supply network and is likely to make upstream protection devices, such as a differential circuit breaker or a classic circuit breaker, react and is also likely to produce transient power supply voltages likely to react with the rest of the electrical installation (domestic appliances).

As the capacitance for limiting leakage currents makes a large contribution to the equivalent charger input common mode capacitance, this disadvantage is remedied, for example, by connecting a damping capacitance and a damping resistance in parallel with the capacitance for limiting leakage currents in order to reduce the amplitude of these transient oscillations. However, this remedy is not always sufficient.

It should be noted that the term “high voltage” refers here to the order of voltage of the electrical network powered by the traction battery whose voltage is close to 400V (volts) when it is fully charged, in contrast to the vehicle on-board network powered by the service battery whose voltage is of the order of 14V.

One of the aims of the invention is to remedy at least some of the disadvantages of the prior art by providing a method and a system for charging a traction battery of an electric or hybrid vehicle, for limiting the draw current from the capacitance components of the charging system at the start of charging.

To this end, the invention proposes a system for charging a traction battery of a traction vehicle, at least partially electric, comprising an input filtering step designed to be connected to a power supply network, said filtering step comprising a capacitance for limiting leakage currents capable of being connected, through a switch of the filtering step, between on one hand at least one power supply phase connection or a neutral connection of said charging system, and on the other, a ground of said charging system, said charging system being characterized in that it further comprises:
control means for charging parasitic capacitances of said charging system without transferring energy from said power supply network to said traction battery while said power supply network is connected to said charging system,
time delay means activated by said control means, and capable of closing said switch of the filtering step when a delay time frame higher than or equal to a predetermined time frame expires,
and charging activation means for transferring energy between said power supply network and said traction battery, said switch of the filtering step being closed.

Thanks to the invention, the capacitance for limiting leakage currents is not immediately connected to the network power supply, allowing the other capacitance components to charge with a lower draw current than when the capacitance for limiting leakage currents is connected to the network power supply. After these other capacitance components have charged, the draw current on activating the charge transfer is lower, thus reducing the intensity of the oscillation transient current in a loop of current located at the charging system input. The upstream devices for protecting the power supply network therefore allow charging of the vehicle traction battery even when the latter is subjected to transient phenomena at the start of charging due to the capacitance components of its charging system.

The invention can be used in a charging system using a single-phase or a multiphase power supply network. It should be noted that the capacitance for limiting leakage currents of the charger according to the invention is connected to a phase of the power supply network, or to the neutral of the power supply network, this neutral being able to be reconstituted as described in the document FR2964506.

According to an advantageous characteristic of the charging system according to the invention, said activation means are capable of delaying a transfer of energy between said power supply network and said traction battery until an instant at which the amplitude of a voltage of a power supply phase of said power supply network becomes very low compared with its maximum amplitude.

Thus, at the start of charging the traction battery, the risk that the input loop transient current, being added to other leakage currents linked with the functioning of a converter of the charging system, causes a peak of common mode current likely to make a circuit breaker react to appear is reduced.

According to another advantageous characteristic of the charging system according to the invention, said delay time frame expires at an instant at which the amplitude of a voltage of a power supply phase of said power supply network becomes very low compared with its maximum amplitude, said activation means starting the transfer of energy between said power supply network and said battery from the closing of said switch of the filtering step.

Likewise, the connection of the capacitance for limiting leakage currents to the power supply network at a moment when the power supply voltage amplitude is low allows a reduction to a few kHz of the current amplitudes of the input loop oscillation transient regime and therefore a limitation of the risks of a circuit breaker tripping. The activation of the energy transfer from the power supply network to the traction battery at the same time as this connection allows a reduction of the initialization time of the charging system.

According to another advantageous characteristic of the charging system according to the invention, a damping capacitance and a damping resistance are also connected, through said switch of the filtering step, between on one hand said at least one power supply phase connection or said neutral connection of said charging system, and on the other said ground of said charging system.

This damping capacitance and this damping resistance further allow the amplitude of the input loop oscillations to be reduced during the transient regime.

Advantageously, when the charging system according to the invention comprises a rectifying step capable of being connected to the power supply network via the input filtering step, and a voltage step-up step connected between said rectifying step and said traction battery, said rectifying and voltage step-up steps comprising switches, said control means are capable of making the switches of the rectifying step switch over through a pulse width modulation control, the switches of the voltage step-up step remaining open, during said delay time frame.

Charging of the capacitance components of the charging system before the transfer of energy between the power supply network and the traction battery therefore takes place without adding any supplementary components to the charging system.

Alternatively, when the charging system according to the invention comprises a rectifying step capable of being connected to the power supply network via the input filtering step, and a voltage step-up step connected between said rectifying step and said traction battery, said rectifying and voltage step-up steps comprising switches which are initially open, and when the power supply network is single-phase, said control means are capable of controlling the closing of the low switches of said rectifying step at an instant at which the voltage amplitude of the power supply phase of the single-phase network becomes very low compared with its maximum amplitude, before the activation of said time delay means.

This alternative embodiment also makes it possible not to add supplementary components to the charging system in order to embody the invention. It furthermore makes it possible to limit further the current draw of the capacitance components of the charging system before the switch of the filtering step closes. This alternative embodiment can be transposed to the three-phase case, although it is slightly more complicated to implement in this particular case.

Advantageously in this alternative embodiment using a single-phase power supply network, said control means are capable of accompanying said closing of the low switches of said rectifying step with the closing of a high switch of said rectifying step, ensuring functioning of said charging system in free wheel phase before the activation of an energy transfer between said power supply network and said traction battery.

This implementation allows the charging system to transfer energy from the power supply network to the battery from the closing of the switch of the filtering step without beforehand reconfiguring the switches of the rectifying step.

The invention also relates to a method for charging a traction battery of a traction vehicle, at least partially electric, a charging system of said vehicle having been connected beforehand to an electrical power supply network comprising at least one power supply phase and one neutral, said method being characterized in that it comprises:
a step of controlling said charging system, capable of charging parasitic capacitances of said charging system without transferring energy from said power supply network to said traction battery,
a step of connecting a capacitance for limiting leakage currents between on one hand a connection to said at least one power supply phase or to said neutral and on the other a ground of said charging system, said connecting step taking place when a time frame higher than or equal to a predetermined time frame expires,
and a step of transferring energy between said power supply network and said traction battery, following the step of connecting said capacitance for limiting leakage currents.

Said step of transferring energy preferably starts at an instant at which the voltage amplitude of said at least one power supply phase becomes very low compared with its maximum amplitude.

Said step of transferring energy advantageously immediately follows the step of connecting the capacitance for limiting leakage currents.

When the charging system according to the invention comprises a rectifying step connected to the power supply network, and a voltage step-up step connected between said rectifying step and said traction battery, said rectifying and voltage step-up steps comprising switches, the control step comprises for example a step of closing the switches of the rectifying step, using a pulse width modulation control, the switches of the voltage step-up step remaining in the open position during this control step.

Alternatively, when the charging system according to the invention comprises a rectifying step connected to the power supply network, the latter being single-phase, and a voltage step-up step connected between said rectifying step and said traction battery, said rectifying and voltage step-up steps comprising switches, the control step comprises a step of closing the low switches of the rectifying step at an instant at which the voltage amplitude of said at least one power supply phase becomes very low compared with its maximum amplitude, the switches of the voltage step-up step remaining in the open position during this control step.

In this alternative, the closing of the low switches of the rectifying step is preferably accompanied by the closing of a high switch of said rectifying step, ensuring functioning of the charging system according to the invention in free wheel phase before the step of transferring energy between said power supply network and said traction battery.

The charging method according to the invention has similar advantages to those of the charging system according to the invention.

Other characteristics and advantages will emerge on reading a preferred embodiment described with reference to the figures, in which:

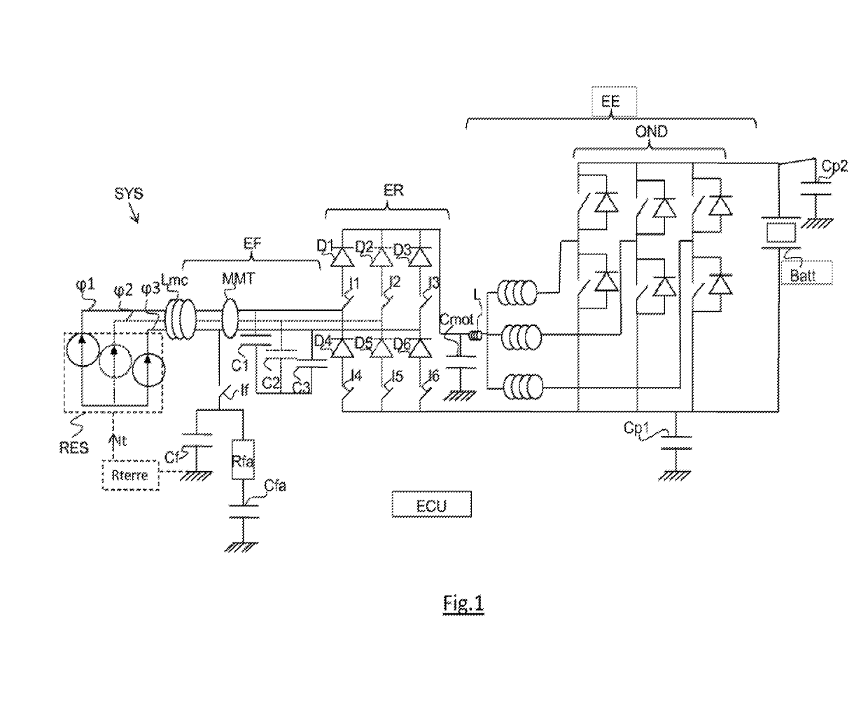

FIG. 1 shows a charging system according to the invention in this preferred embodiment,

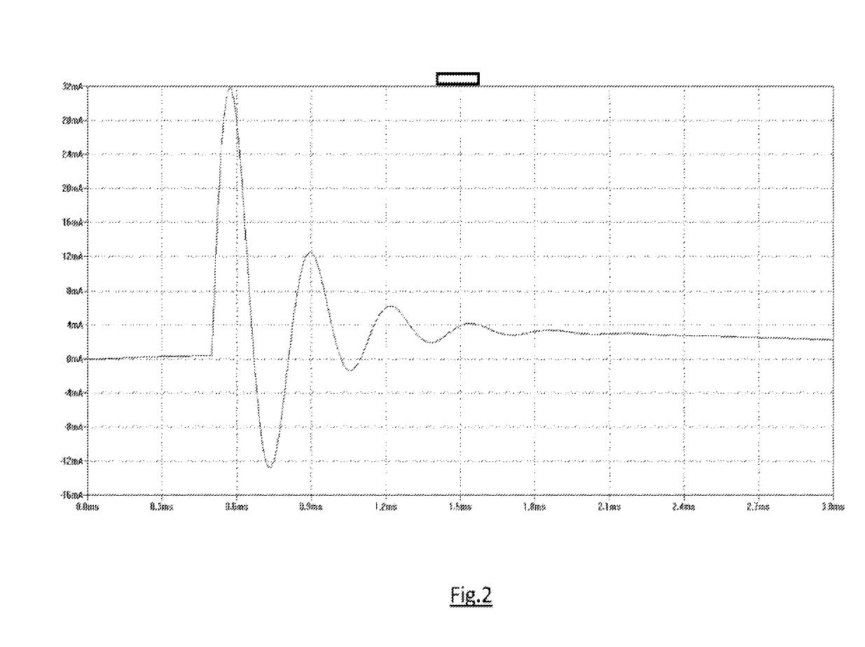

FIG. 2 shows a measurement of the ground connector current of an electric or hybrid vehicle not implementing the invention,

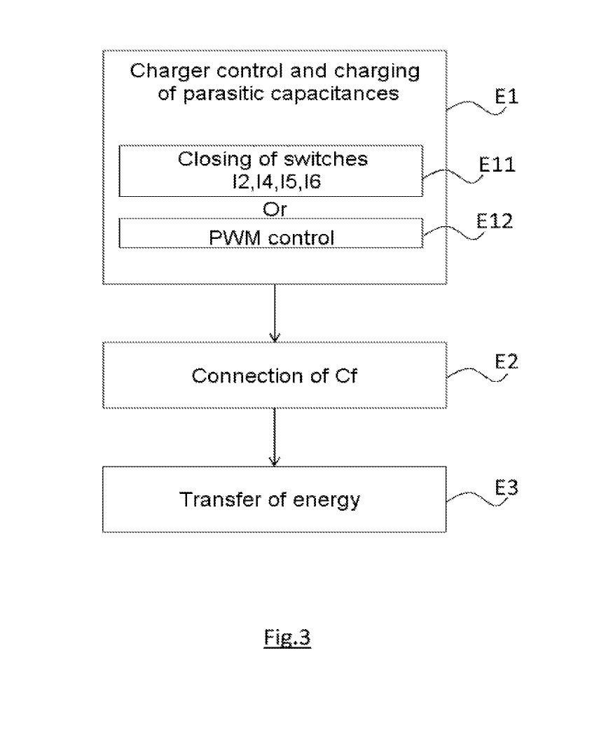

FIG. 3 shows the steps of the charging method according to the invention in this preferred embodiment,

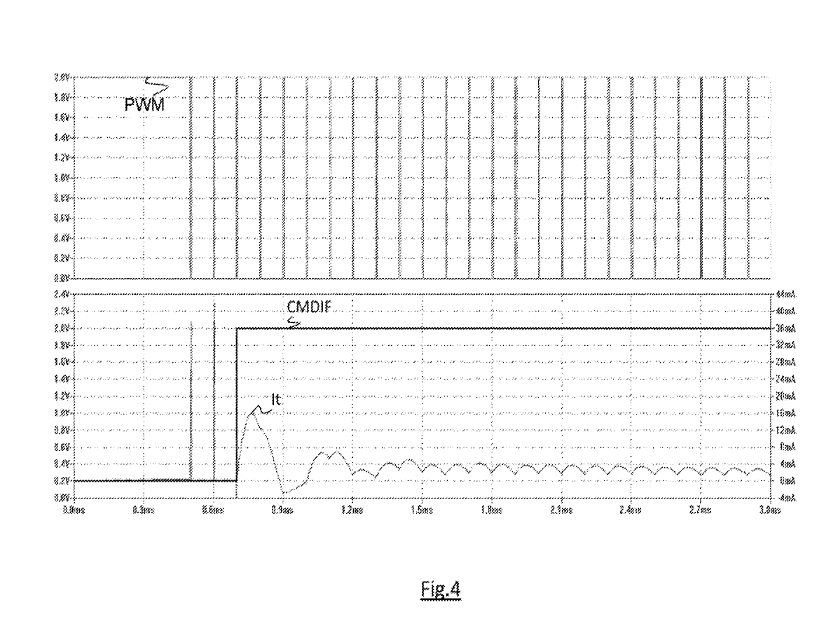

and FIG. 4 shows the power supply of a pulse width modulation control, together with a measurement of the ground connector current of an electric or hybrid vehicle implementing the invention.

According to a preferred embodiment of the invention, a charging system SYS according to the invention, shown in FIG. 1, is connected to a power supply network RES. The charging system SYS is a built-in charging system for a traction battery of an electric or hybrid vehicle.

In this preferred embodiment of the invention, the charging system SYS is not isolated from the network RES by a galvanic transformer, and uses the topology described in patent application FR2964506. However, the invention is applicable to other types of charger, for example, a charger galvanically isolated from the network RES, or a resonance charger.

The charging system SYS makes it possible to recharge the battery Batt of an electric or hybrid vehicle from a three-phase or single-phase power supply network RES. The functioning of the charging system SYS when the power supply network RES is three-phase is described in detail in patent FR2964510. The functioning of the charging system SYS when the power supply network RES is single-phase is described in detail in patent FR2974253. In this embodiment example of the invention, the power supply network RES comprises a neutral phase connected to ground. However, the invention is not limited to a utilization on this type of power supply network, as the charging system SYS also functions on a network in which the network neutral is not directly connected to ground, for example.

The charging system SYS comprises an input filtering step EF comprising three capacitances C1, C2, C3, each comprising a first extremity and a second extremity. The capacitances C1, C2, C3 are connected as a star at their first extremities and each connected at their second extremities to a phase connection φ1, φ2, or φ3 of the power supply network RES, at the input of the filtering step EF. The output of the input filtering step EF is connected to a rectifying step ER.

When the power supply network RES is a three-phase network, the three phase connections φ1, φ2, or φ3 at the input of the input filtering step EF are each connected to a power supply phase of the power supply network RES. When the power supply network RES is a single-phase network, only two phase connections φ1 and φ3 at the input of the input filtering step EF are connected to the power supply network RES, one to the power supply phase of the single-phase network and the other to the neutral phase of the single-phase network. In this case, no current circulates in the capacitance C2 and an arm of the rectifying step ER to which the capacitance C2 is connected. This part of the charging system SYS, unused when it is connected to a single-phase network, is shown by dotted lines on FIG. 1.

The rectifying step ER comprises three arms whose center points are its inputs and are each connected at their second extremities to a capacitance C1, C2 or C3 of the filtering step EF. Each arm respectively comprises, installed in series between its center point and the negative terminal of the battery Batt forming a first output of the rectifying step ER:
a respective diode D4, D5 or D6 whose cathode is attached to the center point of the arm, and
a respective “low” switch I4, I5 or I6, connected on one side to the anode of the respective diode D4, D5 or D6 and on the other side to the negative terminal of the battery Batt. “Low” switch here is a switch of the rectifying step ER connected to the negative terminal of the battery Batt.

Each arm of the rectifying step ER also comprises, installed in series between its center point and a second output of the rectifying step ER, connected to a first input of a voltage step-up step EE:
a respective diode D1, D2 or D3 whose cathode is attached to the second output of output of the rectifying step ER,
a respective “high” switch I1, I2 or I3, connected on one side to the anode of the respective diode D1, D2 or D3 and on the other side to the center point of the arm of the rectifying step ER. “High” switch here is a switch of the rectifying step ER connected to the center point of an arm of the rectifying step ER.

The “low” and “high” switches of the rectifying step ER are power transistors such as Insulated Gate Bipolar Transistors (IGBT).

The voltage step-up step EE comprises, installed in series between its first input and a first output of the voltage step-up step EE connected to the positive terminal of the battery Batt:
an inductance L
a traction motor comprising three stator coils,
and an inverter step OND.

The inductance L is an inductance having a much lower value than that of the traction stator coils to which the inductance L is connected through the neutral point of the traction motor. Each of these stator coils is also connected, at its extremity not connected to the neutral point of the motor, to an input of the inverter step OND, which is a center point of an arm connected, via a diode installed in parallel with a power switch, to the positive terminal of the battery Batt. Each center point of the three arms of the inverter step OND is also connected, via a diode installed in parallel with a power switch, to the negative terminal of the battery Batt, which forms both the second output and the second input of the voltage step-up step EE.

This charging system SYS comprises several parasitic capacitance components, such as:
a parasitic capacitance Cp1 situated between the negative terminal of the battery Batt and the ground of the charging system SYS, which here is the vehicle chassis,
a parasitic capacitance Cp2 situated between the positive terminal of the battery Batt and the ground of the charging system SYS,
and a parasitic capacitance Cmot between the first input of the voltage step-up step EE and the ground of the charging system SYS.

A ground connector on the vehicle charging cable allows the ground of the charging system SYS to be connected to a ground connector of the power supply network RES.

In order to limit leakage currents transiting on this ground connector through a ground resistance Rterre, the filtering step EF comprises a capacitance Cf connected between a power supply or neutral phase φ3 of the power supply network RES and the ground of the charging system SYS. This capacitance Cf, of the order of one microfarad, is called, in this application, “capacitance for limiting leakage currents”. However, it should be noted that in other embodiments of the invention, this capacitance for “limiting leakage currents” is for example made up of several capacitances connected between one of the phases of the network RES and the vehicle ground, playing a filtering role preponderant over the function of limiting leakage currents, which is hence secondary. For example, if the capacitances C1, C2 and C3 were connected to the vehicle ground at their first extremities, they could play the role of capacitance for limiting leakage currents.

At the start of recharging the battery Batt through the charging system SYS, the parasitic capacitances Cp1, Cp2 and Cmot, together with the capacitance Cf for limiting leakage currents, create a current draw passing through the ground connector. A resonant current It, shown in FIG. 2, is thereby formed, circulating in an input loop comprising the ground resistance Rterre, the network RES, an equivalent common mode inductance Lmc and the capacitance Cf for limiting leakage currents. On FIG. 2, the axis of the abscissas shows time in milliseconds, while the axis of the ordinates shows the amplitude of the current It in milliamperes. This current It resonates at a frequency of a few kilohertz and is likely to cause protection circuit breakers upstream of the charging system SYS to trip, the equivalent common mode inductance Lmc being of the order of a few microhenrys. It should be noted that this inductance Lmc does not physically exist in the charging system SYS but represents the equivalent inductance existing at the input of the charging system SYS.

In order to limit this resonant current, a damping capacitance Cfa of the order of one microfarad, installed in series with a damping resistance Rfa of the order of 100 Ohms, are connected in parallel with the terminals of the capacitance Cf for limiting leakage currents. As variants, other installations of the damping capacitance Cfa and of the damping resistance Rfa are possible. For example, as a variant, the damping resistance Rfa is installed in series with the capacitance Cf for limiting leakage currents, and the damping capacitance Cfa is installed in parallel with this series installation including the damping resistance Rfa and the capacitance Cf for limiting leakage currents.

However, as these damping components are not always effective against unwanted tripping of the protections upstream of the charging system SYS, the charging system SYS includes a switch If connected between the capacitance Cf for limiting leakage currents and the power supply or neutral phase φ3 of the power supply network RES. This switch If is controlled by electronic control means ECU using a prior art machine. The control means ECU also control the switches I1 to I6 of the rectifying step ER and the switches of the inverter step OND.

The control means ECU further comprise means of delaying the closing of the switch If and means of activating charging authorizing a transfer of energy between the network RES and the battery Batt. These activation means consist for example in adequate controlling of the switches of the rectifying ER and inverter OND steps.

The control means ECU are therefore capable of retarding a start of charging of the charging system SYS by delaying closing of the switch If so as to limit the draw current of the capacitance components of the charging system SYS at the time of this closing.

The control means ECU furthermore receive voltage measurements of the power supply phases of the network RES thanks to the means MMT of measuring voltage. These voltages measured between each power supply phase of the network RES and the neutral of the network RES make it possible to control the switches of the rectifying step ER and of the inverter step OND, but also to determine an optimum instant for closing the power switch If.

With reference to FIG. 3, a method for charging the traction battery Batt according to the invention is shown in the form of an algorithm comprising steps E1 to E3.

The method is set in operation at least partially in the control means ECU, which are software means implemented in one or more computers of the vehicle.

It is assumed beforehand that the charging system SYS is connected to the electrical network RES.

The step E1 is a control of the charging system SYS, making it possible to charge the parasitic capacitances Cp1, Cp2 and Cmot without transferring energy from the power supply network RES to said traction battery Batt.

For that, in a main embodiment variant E11 of the step E1, the control means ECU close the low switches I4, I5, I6 and the high switch I2 of the rectifying step ER, the switches of the inverter step OND remaining open, together with the switches I1 and I3. This controlling of switches makes it possible to charge, at least partially, the capacitances Cp1, Cp2 and Cmot, while preparing a free wheel phase with a view to a transfer of energy between the power supply network RES and the battery Batt.

When the power supply network RES is single-phase, the power supply phase of the network RES being for example φ1 and the neutral phase φ3, the closing of the switches I4, I5, I6 and I2 preferably takes place at an instant at which the voltage amplitude of the power supply phase φ1 becomes very low compared with its maximum amplitude, for example at its passage through zero volts.

When the power supply network RES is three-phase, the switches I4, I5, I6 and I2 are also closed in this main embodiment variant E11, preferably in a sequential manner, the switches I4, I5, I6 and I2 each closing advantageously at the passage through zero volts of the phase to which the corresponding switch is connected.

Alternatively, in another embodiment variant E12 of this step E1, the control means ECU alternately control the switches I1, I2, I3, I4, I5 and I6 to the open then closed positions by pulse width modulation (PWM), the switches of the voltage step-up step EE together with the switch If remaining in the open position during this step E1. This controlling of the switches I1, I2, I3, I4, I5 and I6 is shown on the PWM curve of FIG. 4, the axis of the ordinates showing the amplitude in volts of the controlling of the switches and the axis of the abscissas showing time in milliseconds.

The next step E2, set in operation by the time delay means of the control means ECU, is the connection of the capacitance Cf for limiting leakage currents to the phase φ3 by closing the switch If when a time frame higher than or equal to a predetermined time frame expires. This time delay is started from the closing of the switches I4, I5, I6 and I2 at step E1, or from the start of pulse width modulation controlling in step E1. The predetermined time frame should allow the first peak of the resonant current It circulating through the ground connector to pass. This predetermined time frame is of the order, for example, of one millisecond in this preferred embodiment of the invention.

Finally, the step E3, set in operation by the means of activating the control means ECU, is the transfer of energy between the power supply network RES and the traction battery Batt, once the switch If has been closed by the control means ECU. The start of this transfer of energy, effected by a pulse width modulation control of the switches of the rectifying step ER and of the voltage step-up step EE, coincides for example with the closing of the switch If at step E2.

When the power supply network RES is single-phase, the power supply phase of the network RES being for example φ1 and the neutral phase φ3, this transfer preferably starts at an instant at which the voltage amplitude of the power supply phase φ1 becomes very low compared with its maximum amplitude, for example at its passage through zero.

When the power supply network RES is three-phase, this transfer preferably starts so as to close the switches of the rectifying step ER sequentially at the passages through zero of the corresponding power supply phases.

The invention makes it possible to reduce by half the amplitude of the current It as shown on the bottom diagram of FIG. 4, the CMDIF curve corresponding to the controlling of the switch If. On this bottom diagram of FIG. 4, the axis of the ordinates on the left corresponds to the amplitude scale of the current used for the CMDIF curve, and the axis of the ordinates on the right corresponds to the amplitude scale of the current used for the curve of the current It. The axis of the abscissas is the same as for the PWM curve. This curve of the current It was obtained with the charging system SYS powered in single-phase, with a ground resistance Rterre of the order of 0.01 Ohms, a parasitic capacitance Cp1 of the order of 80 nanofarads and a parasitic capacitance Cp2 of the order of 40 nanofarads.

It should be noted that although in this preferred embodiment of the invention, the switches I4, I5, I6 and I2 are closed in order to charge the parasitic capacitances of the charging system SYS, the invention can be embodied by closing only some of these switches, for example the switches I4, then I6, then I5, then I2. In fact, even if all of the parasitic capacitances are not charged or are partially charged, the invention functions if the draw current produced by all of the parasitic capacitances of the charging system when the switch If closes is sufficiently limited.

1-13. (canceled)

14. A system for charging a traction battery of a traction vehicle that is at least partially electric, comprising:
an input filter to be connected to a power supply network, said filter comprising a capacitance for limiting leakage currents configured to be connected, through a switch of the filter, between at least one power supply phase connection or a neutral connection of said charging system, and a ground of said charging system;
control means for charging parasitic capacitances of said charging system without transferring energy from said power supply network to said traction battery while said power supply network is connected to said charging system;
time delay means activated by said control means, for closing said switch of the filter when a delay time frame higher than or equal to a predetermined time frame expires; and
charging activation means for transferring energy between said power supply network and said traction battery, said switch of the filter being closed.

15. The system for charging a traction battery as claimed in claim 14, wherein said activation means are delay a transfer of energy between said power supply network and said traction battery until an instant at which the amplitude of a voltage of a power supply phase of said power supply network becomes very low compared with its maximum amplitude.

16. The system for charging a traction battery as claimed in claim 15, wherein said delay time frame expires at an instant at which the amplitude of a voltage of a power supply phase of said power supply network becomes very low compared with its maximum amplitude, said activation means starting the transfer of energy between said power supply network and said battery from the closing of said switch of the filter.

17. The system for charging a traction battery as claimed in claim 14, wherein a damping capacitance and a damping resistance are also connected, through said switch of the filter, between said at least one power supply phase connection or said neutral connection of said charging system, and said ground of said charging system.

18. The system for charging a traction battery as claimed in claim 14, wherein said charging system comprises a rectifier to be connected to the power supply network via the input filter, and a voltage step-up connected between said rectifier and said traction battery, said rectifier and voltage step-up comprising switches, said control means are configured to make the switches of the rectifier switch over through a pulse width modulation control, the switches of the voltage step-up remaining open, during said delay time frame.

19. The system for charging a traction battery as claimed in claim 14, wherein said charging system comprises a rectifier to be connected to the power supply network via the input filter, and a voltage step-up connected between said rectifier and said traction battery, said rectifier and voltage step-up comprising switches which are initially open, and said power supply network being single-phase, said control means are configured to control the closing of the low switches of said rectifier at an instant at which the voltage amplitude of the power supply phase of said single-phase network becomes very low compared with its maximum amplitude, before the activation of said time delay means.

20. The system for charging a traction battery as claimed in claim 19, wherein said control means are configured to accompany said closing of the low switches of said rectifier with the closing of a high switch of said rectifier, ensuring functioning of said charging system in free wheel phase before the activation of an energy transfer between said power supply network and said traction battery.

21. A method for charging a traction battery of a traction vehicle that is at least partially electric, a charging system of said vehicle having been connected beforehand to an electrical power supply network comprising at least one power supply phase and one neutral, said method comprising:
controlling said charging system, including charging parasitic capacitances of said charging system without transferring energy from said power supply network to said traction battery;
connecting a capacitance for limiting leakage currents between a connection to said at least one power supply phase or to said neutral, and a ground of said charging system, said connecting taking place when a time frame higher than or equal to a predetermined time frame expires; and
transferring energy between said power supply network and said traction battery, following the connecting said capacitance for limiting leakage currents.

22. The method for charging a traction battery as claimed in claim 21, wherein said transferring energy starts at an instant at which the voltage amplitude of said at least one power supply phase becomes very low compared with its maximum amplitude.

23. The method for charging a traction battery as claimed in claim 21, wherein said transferring energy immediately follows the connecting the capacitance for limiting leakage currents.

24. The method for charging a traction battery as claimed in claim 21, wherein, when said charging system comprises a rectifier connected to the power supply network and a voltage step-up connected between said rectifier and said traction battery, said rectifier and voltage step-up comprising switches, the controlling comprises closing the switches of said rectifier, using a pulse width modulation control, the switches of said voltage step-up remaining in the open position during the controlling.

25. The method for charging a traction battery as claimed in claim 21, wherein, when said charging system comprises a rectifier connected to the power supply network, said power supply network being singe-phase, and a voltage step-up connected between said rectifier and said traction battery, said rectifier and voltage step-up comprising switches, the controlling comprises closing the low switches of said rectifier at an instant at which the voltage amplitude of said at least one power supply phase becomes very low compared with its maximum amplitude, the switches of said voltage step-up remaining in the open position during the controlling.

26. The method for charging a traction battery as claimed in claim 25, wherein the closing of the low switches of the rectifier is accompanied by the closing of a high switch of said rectifier, ensuring functioning of said charging system in free wheel phase before the transferring energy between said power supply network and said traction battery.
